(19) United States
(12) Patent Application Publication
(10) Pub. No.: US 2014/0302418 A1
(43) Pub. Date: Oct. 9, 2014

(54) MEMBRANE-ELECTRODE ASSEMBLY COMPRISING TWO COVER LAYERS

(71) Applicants: Bernd Bauer, Vaihingen (DE); Tomas Klicpera, St. Ingbert (DE)

(72) Inventors: Bernd Bauer, Vaihingen (DE); Tomas Klicpera, St. Ingbert (DE)

(73) Assignee: FuMa-Tech Gesellschaft für funktionelle Membranen und Anlagentechnologie mbH, St. Ingbert (DE)

(21) Appl. No.: 13/994,194

(22) PCT Filed: Dec. 13, 2011
(86) PCT No.: PCT/EP2011/072603

§ 371 Date: Dec. 10, 2013

(30) Foreign Application Priority Data
Dec. 16, 2010 (DE) 10 2010 063 254.6

(51) Int. Cl. H01M 8/02; H01M 8/12

(52) U.S. Cl. CPC H01M 8/0284; H01M 8/0273; H01M 8/12; H01M 2008/1095
USPC 429/480; 429/482; 429/483

(57) ABSTRACT

The invention relates to a membrane-electrode assembly (100), comprising two electrodes (110, 110′) and a membrane (120), preferably a polymer electrolyte membrane (PEM), which is disposed between the two electrodes (110, 110′), wherein the membrane-electrode assembly (100) comprises a first cover layer (130; 130′) and a second cover layer (140; 140′) on at least one flat side, preferably on both flat sides of the membrane (120), characterized in that the first cover layer (130; 130′) covers an edge face (125, 125′) of the membrane (120) and an electrode edge face (115, 115′) facing the membrane (120) and the second cover layer (140; 140′) partially covers the first cover layer (130; 130′), preferably in edge regions of the membrane-electrode assembly (100). The present invention further relates to a fuel cell which comprises a membrane-electrode assembly (100).

The invention is related to a membrane-electrode assembly (MEA) comprising two cover layers, and to a fuel cell including said MEA.

Due to the high efficiency achievable in theory and the low-emission technology involved, polymer electrolyte membrane fuel cells (PEMFCs) are considered to be particularly seminal sources of energy.

However, a basic problem with conventional PEMFCs is the loss of power with increasing operating time. One the one hand, said effect is due to the fact that in particular at higher operating temperatures there is an increasing amount of water evaporating the longer the fuel cell is in operation. On the other hand, part of the water is “entrained” by protons during their migration through the membrane. In both cases, the electric resistance in the fuel cell is increasing, whereby the overall performance thereof is decreasing.

A further problem is that the polymer electrolyte membranes (PEMs) can absorb water up to a certain degree, thereby swelling. At high temperatures, the polymer electrolyte membranes can release the water again, thereby shrinking. Depending on the design of the fuel cells, such dimensional variations of the PEMs are countered by substantial mechanical resistance. In that context, mechanical stresses and strains can occur, for example in the form of tensile or shearing forces, that expand, compress or shear the polymer electrolyte membranes. Due to such mechanical stresses and strains the membranes may be damaged, what in turn may result in leakages and short-circuit faults. In particularly adverse cases, there may even be membrane failure occurring, for example by rupture of the polymer electrolyte membrane. The consequences of such a membrane failure are inter alia a considerable performance loss of the PEMFC up to a total breakdown, and intermingling of reactant materials, what in particular with H₂O₂ fuel cells can lead to production of a hazardous oxyhydrogen gas mixture.

DE 103 59 787 A1 describes an electrochemical cell including a membrane-electrode assembly (MEA), wherein the membrane is embraced by a spacer sealing rim to reduce mechanical stresses and strains.

DE 102 35 360 A1 discloses a MEA, wherein the membrane is provided with a polyimide layer on the surfaces facing the electrodes.

A membrane-electrode assembly including a sealing film disposed between the electrodes and the membrane on the peripheral side is known from U.S. Pat. No. 5,464,700.

Object of EP 1 624 511 A1 is a membrane-electrode assembly including a sealing material on the front and rear face of the polymer electrolyte membrane, wherein the polymer electrolyte membrane has one or more recesses and the sealing material on the front face of the polymer electrolyte membrane contacts the sealing material on the rear face of the polymer electrolyte membrane.

EP 1 624 512 A2 discloses a membrane-electrode assembly including two sealing materials on the edges thereof, wherein both the sealing materials are interconnected by a recess of one of the sealing materials.

U.S. Pat. No. 7,553,578 B2 discloses fuel cells, wherein edge zones of a polymer electrolyte membrane protruding beyond electrodes are covered by a sealing film.

A device for manufacturing fuel cells provided respectively with a sealing between the electrodes and a polymer electrolyte membrane, are the object of WO 2004/021489 A2. The constituent components of the fuel cell are pressed against each other by means of heat and pressure such that an adhesive bonding between the sealing and the electrode is formed.

Another membrane-electrode assembly provided with a sealing is known from EP 0 586 461 B1.

DE 10 2004 060 278 A1 describes a membrane-electrode assembly, wherein between the polymer electrolyte membrane and the electrode substrates a thermoplastic synthetic material is incorporated in the surface of the electrode substrates, so that an adhesive bonding is obtained between the electrode substrates and the thermoplastic synthetic material, but not between the thermoplastic synthetic material and the polymer electrolyte membrane.

Thus, the aim of the present invention is to provide a membrane-electrode assembly, wherein the problems known from the state of the art are overcome and which is in particular suitable for high-temperature applications.

The aim is achieved according to the invention by a membrane-electrode assembly (MEA) presenting the features of the independent claim 1. Preferred embodiments of the membrane-electrode assembly are the object of dependent claims 2 through 15. Another object of the invention is related to a fuel cell according to claim 16. The wording of all the claims is hereby incorporated into the content of the present description by explicit reference.

The membrane-electrode assembly (MEA) according to the invention comprises two electrodes and a membrane, preferably a polymer electrolyte membrane (PEM), which is disposed between the two electrodes. The membrane-electrode assembly includes a first and a second cover layer on at least one flat side of the membrane, preferably on both flat sides of the membrane. The first cover layer covers an edge face of the membrane and an electrode edge face facing the membrane. The second cover layer partially covers the first cover layer, in particular only partially, preferably in edge regions of the membrane-electrode assembly.

By means of the two cover layers provided according to the invention, a mechanical reinforcement of the MEA and an improved prevention of leakages is obtainable with particular advantage.

The expression “flat side of the membrane” is meant to designate, in the context of the present invention, a side of the membrane which is facing one of the two electrodes in the MEA. In general, the membrane comprises two opposite flat sides and four end faces, in general disposed perpendicular to the flat sides.

An “edge face of the membrane” or a “membrane edge face” is meant to designate, in the context of the present invention, a face of the membrane extending on a flat side of the membrane along the membrane edge or the membrane periphery, preferably in the type of a picture frame. In contrast, end faces of the membrane are meant to be excluded from the expression “membrane edge face”.

An “edge face of the electrode” or an “electrode edge face” is meant to designate, in the context of the present invention, a face of the electrode extending on a flat side of the electrode along the electrode edge or the electrode periphery, preferably in the type of a picture frame. In contrast, end faces of the electrode(s) are meant to be excluded from the expression “electrode edge face”.

The expression “flat side of the electrode” is meant to designate, in the context of the present invention, a side of the electrode which is facing the membrane in the MEA. In general the electrodes comprise two opposite flat sides and four end faces, in general disposed perpendicular to the flat sides.

Due to the spatial location or arrangement in the MEA, the first cover layer may be understood to be an inner cover layer and the second cover layer may be understood to be an outer cover layer.

In a preferred embodiment the membrane, in particular the membrane edge face, protrudes beyond the electrode, in particular the electrode edge face.

What may further be provided according to the invention is that the membrane protrudes beyond the electrode by a surface area per flat side of the membrane which has an area proportion between 0.01% and 20%, in particular 0.05% and 10%, preferably 1% and 5%, in relation to the total surface area of the membrane flat side.

Preferably the membrane edge face covered by the first cover layer is larger than the electrode edge face covered by the first cover layer.

According to the invention the membrane edge face covered by the first cover layer may have an area proportion between 0.1% and 30%, in particular 0.5% and 15%, preferably 2% and 10%, in relation to the total surface area of a membrane flat side.

The electrode edge face covered by the first cover layer may have an area proportion between 0.01% and 20%, in particular 0.5% and 10%, preferably 1% and 5%, in relation to the total surface area of the electrode flat side.

In a particularly preferred embodiment, the membrane and at least one of the two electrodes, preferably both the electrodes, are spaced from one another by the first cover layer. In other words, the first cover layers acts as a kind of spacer between the membrane and at least one of the two electrodes with particular advantage in the present embodiment. Preferably the membrane and at least one of the two electrodes are spaced from one another by means of the first cover layer and forming a cavity volume, whereby a mobility of the membrane is improved. Thus, the membrane can take an improved part in dimensional variations occurring during swelling and shrinking processes.

Preferably, there is a conductive, in particular an acid-containing, preferably a phosphoric acid-containing, liquid layer present between the membrane and at least one of the two electrodes, preferably both the electrodes. By this means a conductivity of the MEA may be improved and the electric resistance reduced with particular advantage.

In another embodiment, the first cover layer protrudes beyond the membrane edge face. Said embodiment as well has the advantage that the first cover layer acts as a spacer, however in this case, preferably relative to the second cover layer, whereby a freedom of mobility of the membrane and thus the potential of the membrane to pass through dimensional variations without a resistance occurring that might damage the membrane, as the case may be, is also improved.

Furthermore it is preferred that the first cover layer is partially disposed between the membrane and the second cover layer.

In a preferred embodiment, the second cover layer covers a surface section protruding beyond the electrode edge face of the first cover layer.

In a particularly preferred embodiment, the second cover layer covers a surface section of the first cover layer protruding beyond the electrode edge face and the membrane edge face.

In a further embodiment, the second cover layer extends from an electrode edge face facing away from the membrane via an end face of the electrode adjacent thereto up to a surface section of the first cover layer adjacent to the electrode end face and protruding beyond the electrode edge face and preferably the membrane edge face. The protruding surface section of the first cover layer is at least partially, preferably completely, covered by the second cover layer.

Furthermore preferred according to the invention is further also that end faces of the protruding surface section of the first cover layer facing away from the membrane and the electrodes, respectively, as described in the above embodiments, are covered by the second cover layer.

In principle, even the end faces of the membrane may be covered by the first and/or the second cover layer.

In a preferred embodiment, the end faces of the membrane are, however, not covered, neither by the first nor by the second cover layer. Particularly preferred is that at least the second cover layer does not share a contact surface with the membrane.

The first and/or the second cover layer, in particular the first and the second cover layer, preferably have a picture frame-type shape or are preferably configured in the type of a picture frame. In other words, the first and/or the second cover layer, in particular the first and the second cover layer, have in general a central recess or aperture defined by the cover layer edges.

In a convenient embodiment, the first and/or the second cover layer, in particular the first and the second cover layer, have a centered, preferably quadrangular, in particular square or rectangular recess or aperture.

Preferably the first cover layer has a centered recess or aperture not smaller than a centered recess or aperture of the second cover layer. Particularly preferred the first and the second cover layer have a centered recess or aperture of the same size.

Furthermore preferred is that the second cover layer has a larger surface area than the first cover layer. In other words, the first cover layer preferably has a smaller two-dimensional extension than the second cover layer.

In principle, the first and the second cover layer can have an equally sized layer thickness. Preferably however, the first and the second cover layer have different layer thicknesses. Particularly preferred is that the first cover layer has a smaller layer thickness than the second cover layer. By means of that feature, on the one hand the electric resistance of the MEA may be decreased due to a minor spacing of membrane and electrodes in case of a first cover layer acting as a spacer. On the other hand, a smaller layer thickness in general means superior material and cost efficiency.

In a further embodiment, the first cover layer has a layer thickness corresponding to at most 90% of the layer thickness of the second cover layer.

The second cover layer can have a layer thickness between 10 μm and 100 μm, in particular 15 μm and 40 μm, preferably 15 μm and 35 μm.

According to a particularly preferred embodiment, the first and/or the second cover layer, preferably the first and the second cover layer, are configured as a film, in particular a cover or sealing film. The film-type configuration of the first and/or the second cover layer presents the advantage that thereby sealing of the MEA, in particular at the edge and peripheral zones thereof, can be achieved in a particular way. Thus, in this manner, permeation of liquid or gaseous components of the MEA towards the exterior may be prevented, for example. Furthermore, a film-type configuration of the first and/or the second cover layer presents also a particularly effective barrier against permeation of liquid or gaseous components from the exterior into the MEA. Thus, in total, the configuration of the first and/or the second cover layer as a film contributes to an improved performance and/or service life of the MEA.

Furthermore preferred according to the invention is that the first and/or the second cover layer, in particular the first and the second cover layer, are not a hot-melt film. Said feature is particularly advantageous in view of a use of the MEA according to the invention in the high-temperature range, for example in a high-temperature fuel cell.

In a particularly preferred embodiment, there is no material joining bonding, in particular no adhering bonding, preferably no adhesive bonding, between the first cover layer and the membrane edge face covered thereby. With particular advantage, said feature also contributes to an improved freedom of mobility of the membrane in that the membrane, for example, when subject to mechanical stresses and strains can slide along the first cover layer. In addition, in the absence of a material joining connection, the first cover layer presents less resistance to possible dimensional variations of the membrane.

In another advantageous embodiment, there is no material joining bonding, in particular no adhering bonding, preferably no adhesive bonding, between the first cover layer and the electrode edge face covered thereby. Thus, the electrodes of the MEA, when subject to compressive stress can slide along the first cover layer, with particular advantage, and thus absorb part of the compressive stress that would otherwise act on the membrane. Thereby, the risk of damaging the membrane may also be reduced.

In a convenient embodiment, the first cover layer and the second cover layer are connected to one another by material joining, in particular are adhesively bonded to another. Furthermore, the second cover layer can be connected to electrode edge faces facing away from the membrane and/or to electrode end faces adjacent thereto by material joining, in particular by adhesive bonding. Therein, the adhesive bonding can be based on an adhesive, like a polysiloxane adhesive and/or polyacrylate adhesive, for example. The embodiments described in this paragraph have the advantage that a particularly effective sealing of the membrane in the edge zones thereof is obtained by said means.

Preferred is that the first and the second cover layer are connected to another by an adhesive layer, wherein the adhesive layer preferably has a thickness between 10 μm and 500 μm, in particular 20 μm and 300 μm. The adhesive layer can be an independent layer or even be a constituent part of one of the two cover layers, preferably the second cover layer. In particular it can be provided according to the invention that one of the two cover layers, preferably the second cover layer, is present as an adhesive film.

The first and/or the second cover layer are preferably made of an elastic material, preferably a polymer. The use of an elastic material for the first and/or the second cover layer has the advantage that thereby likewise less resistance is counteracting to dimensional variations of the membrane, which otherwise could result in damages to the membrane. But also relative to external compressive stresses acting on the MEA and thus on the membrane, an improved absorbing is allowed in case of an elastic first and/or second cover layer.

Preferably, the first and/or the second cover layer are compressible, in particular reversibly compressible. In particular, the first and/or the second cover layer can be configured such that upon a compressive stress of ≧1 Nm acting thereon the respective layer thicknesses may be reduced by at least 0.05%.

In another embodiment, the first and/or the second cover layer are made of a thermally stable material, in particular a polymer. Thus, the MEA according to the invention can be used with particular advantage in the so-called high-temperature range, i.e., in a temperature range above 120° C., in particular between 140° C. and 240° C.

A particularly preferred use considers an employment of the MEA according to the invention in a high-temperature fuel cell.

In another advantageous embodiment, the first and/or the second cover layer are made of a chemically inert material, preferably a polymer. Said feature is particularly advantageous, since undesirable side reactions involving gaseous or liquid reactant materials and/or reaction products of the MEA can be prevented thereby.

The first and the second cover layer can in principle be made of the same material, in particular polymer. Preferred is that the first and the second cover layer are made of different materials, in particular different polymers.

The first and/or the second cover layer are preferably made of a material, in particular a polymer, selected in particular from the group consisting of polyether ether ketone (PEEK), polyphenyl sulfide, polyvinyl sulfide, polyimide, polytetrafluoroethylene, polytetrafluoropropylene, polyhexafluoropropylene, ethylene tetrafluoroethylene (ETFE), copolymers thereof, and mixtures or blends thereof. The polymer ethylene tetrafluoroethylene is a copolymer composed of the monomers ethylene and tetrafluoroethylene.

The use of polyether ether ketone and/or polyphenyl sulfide as a material for the first and/or the second cover layer is particularly preferred.

In a further embodiment, the first cover layer is made of polyether ether ketone and the second cover layer is made of polyphenyl sulfide.

In another embodiment, the second cover layer is composed of at least two sublayers, in particular of two to seven, in particular of two to five sublayers. The sublayers can be made of the same material or be made of different materials. Preferably the sublayers are made of different materials.

In a further embodiment, at least one sublayer of the second cover layer is made of a fluoropolymer, in particular selected from the group consisting of polytetrafluoroethylene, polytetrafluoropropylene, polyhexafluoropropylene, ethylene tetrafluoroethylene, copolymers thereof, and mixtures or blends thereof.

As already mentioned, the membrane of the MEA according to the invention is preferably a polymer electrolyte membrane. In general all proton conducting materials, in particular polymers, can be used therein. However, to increase proton conductivity, a membrane including acids is preferred. There, the acids can be linked to the polymers of the membrane by covalent bonding.

Particularly preferred is that the membrane is doped with an acid, in particular an inorganic acid. Therein, the acid can have a pKₐ value of ≦−4. Examples of adequate acids are sulfuric acid and/or sulfonic acids, in particular alkyl and/or arene sulfonic (aryl sulfonic) acids. Also utile are weaker acids, like phosphoric acid or polyphosphoric acids, for example.

In a preferred embodiment, the membrane has a degree of doping with acid, in particular inorganic acid, of 50% to 700%, in particular 150% to 500%, preferably 250% to 400%, related to the dry net weight of the membrane.

The MEA preferably has a proportion of acid, in particular inorganic acid, between 200% and 500%, in particular 250% and 400%, related to the dry net weight of the membrane.

In an alternative embodiment, the membrane of the MEA according to the invention is doped with a base, in particular an inorganic base, preferably having a pK_{b} value of ≦−4. Examples of adequate bases are selected from the group consisting of sodium hydroxide (NaOH), potassium hydroxide (KOH), magnesium hydroxide (Mg(OH)₂), calcium hydroxide (Ca(OH)₂), lanthanum hydroxide (La(OH)₃), and mixtures thereof. The membrane can have a degree of doping with a base of 10% to 500%, in particular 60% to 300%, preferably 100% to 200%, related to the dry net weight of the membrane. Furthermore the MEA according to the invention can have a proportion of base between 10% and 500%, in particular 60% and 300%, related to the dry net weight of the membrane.

Preferred membranes for the MEA according to the invention are represented by cation exchanger membranes. For example, the membrane for the MEA according to the invention can be made of a polymer which is preferably selected from the group consisting of sulfonated polyvinylidene difluoride, sulfonated fluoropolymers, in particular sulfonated polytetrafluoroethylene, sulfonated polyarylenes, sulfonated polysulfone, sulfonated polyether ether ketone, sulfonated polyphenylene oxide, copolymers thereof, and mixtures thereof.

Further preferred cation exchanger membranes are perfluorosulfonic acid membranes.

Examples of appropriate membranes are commercially available under the names Nafion®, Nafion® N-424, Fumasep® F-10120, Flemion®, Selemion®, Aciplex®, Hyflon®, Aquivion®, and Fumapem® F, for example.

According to the invention, the MEA comprises two electrodes, conveniently two electrochemically active electrodes (anode and cathode) separated one from the other by the membrane, preferably a polymer electrolyte membrane.

The expression “electrode” designates in general an electrically conductive material according to the present invention.

The expression “electrochemically active” indicates that the electrodes are capable of catalyzing oxidation of a fuel, like hydrogen and/or a reformate, and reduction of an oxidant, like oxygen, for example. Said characteristic of the electrodes may be obtained by coating using an appropriate metal, preferably a noble metal, and/or alloys thereof, for example. Appropriate metals may be selected from the group consisting of platinum, palladium, rhodium, iridium, ruthenium, copper, silver, gold, and alloys thereof, for example, in particular alloys with ignoble metals, like lithium, magnesium, calcium, aluminum, lead, titanium, zirconium, vanadium, chromium, molybdenum, manganese, iron, cobalt, nickel, lanthanum and/or cerium, for example.

The electrodes of the MEA according to the invention are preferably gas diffusion electrodes. A gas diffusion electrode is in general composed of at least one gas diffusion layer (GDL) and a catalyst layer facing the membrane, and whereon the fuel cell reaction is occurring (electrochemically active surface). Generally, the gas diffusion layer is composed of at least one macroporous, stabilizing layer and one or more microporous diffusion layers, the so-called carbon base (CB). The macroporous layer can be a graphite paper, for example, and the microporous layer can be a carbon layer, for example. The aim of the gas diffusion layer is mechanical stabilization of the catalyst layer and the membrane, and discharge of the electrodes and heat. In addition the gas diffusion layer provides for a rapid and uniform distribution of educts and for evacuation of products of a fuel cell reaction, for example. The macroporous layer together with the microporous layer and, if present, multiple microporous layers constitutes a so-called electrode substrate.

The above mentioned catalyst layer in general includes catalytically active compounds and catalysts, respectively, that preferably may be the already mentioned noble metals or alloys.

Furthermore, catalytically active compounds and catalysts, respectively, can be present in the form of particles, and have a size in the range of 0.5 nm to 20 nm, in particular 1 nm to 10 nm, preferably 1.5 nm to 5 nm, for example.

In general, the catalyst layer is applied on the above mentioned electrode substrates.

In another embodiment, the MEA according to the invention is arranged between two separator plates, in particular two monopolar separator plates. One of the separator plates preferably includes channels for distributing fuel, and the other separator plate preferably includes channels for distributing oxidant. Both channels are in general facing the MEA.

The present invention is further related to an electrochemical cell, preferably a fuel cell, comprising a membrane-electrode assembly (MEA) according to the present invention. Particularly preferred is that the electrochemical cell is a high-temperature fuel cell, i.e., a fuel cell for a temperature range above 120° C., in particular between 140° C. and 240° C. As an alternative, the electrochemical cell can also be a battery, like a zinc-air battery, an accumulator, like a vanadium redox accumulator, for example, or an electrolysis cell, in particular a water electrolysis cell. As to further features and advantages, in particular in view of the membrane-electrode assembly, reference is made to the above description as a whole.

Finally, the present invention is also related to a fuel cell stack comprising at least one membrane-electrode assembly (MEA), preferably two or more membrane-electrode assemblies (MEAs), according to the present invention. The fuel cell stack comprises bipolar separator plates, as a function of the number of fuel cells in the stack, and two monopolar separator plates being end plates of the stack. As to further features and advantages, in particular in view of the membrane-electrode assemblies, reference is again made to the above description as a whole.

Further advantages and features of the invention will become apparent from the following description of preferred embodiments by reference to the description of drawings, and the related drawings. Therein, individual features may be embodied alone or in combination of multiple features together. The described embodiments are intended merely for illustration and better understanding of the invention, and are in no way to be interpreted as limiting.

The figures are schematic illustrations of:

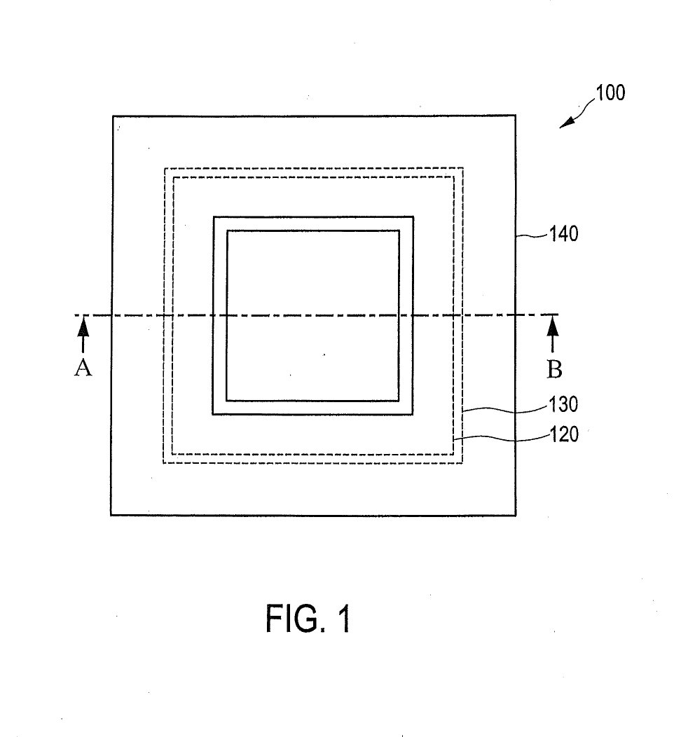

FIG. 1: a plan view of a preferred embodiment of a membrane-electrode unit according to the invention,

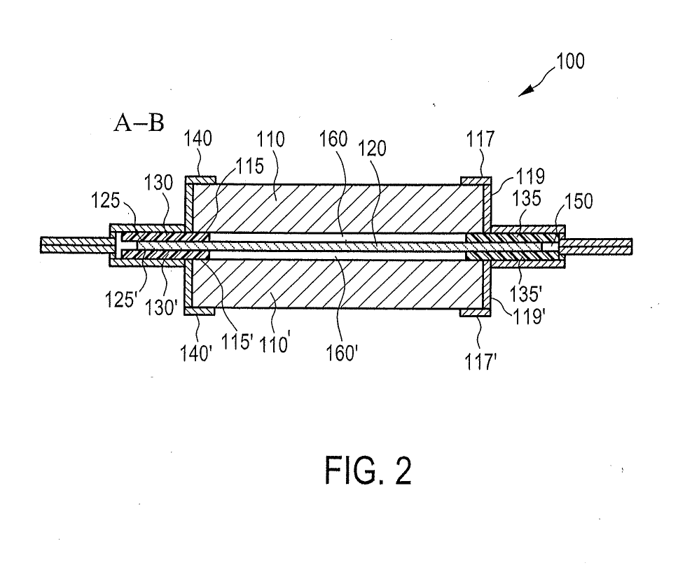

FIG. 2: a cross-sectional view of the membrane-electrode unit illustrated in FIG. 1 along the dashed line A-B,

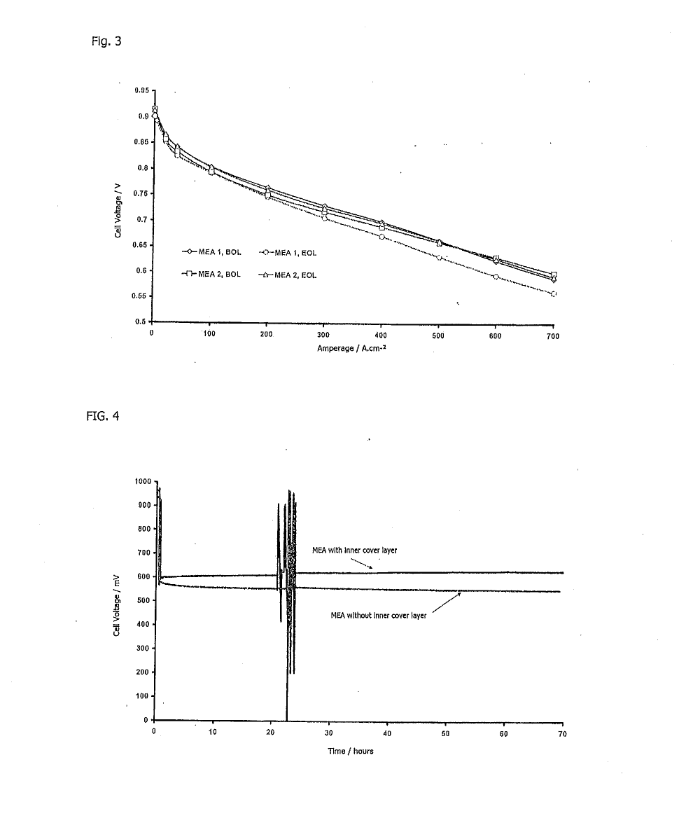

FIG. 3: cell voltage-amperage characteristics (7 layer Fumea® CCM, Fumapem® F-930 membrane, T=80° C., p=1 bar, 60% air moisture on the cathode, 80% H₂ moisture on the anode, MEA 1: without inner protective layer; MEA 2: with inner protective layer, short time operation: 300 h of On/Off cycles), and

FIG. 4: cell voltage-time characteristics (HTPEM-Fumea®, T=160° C., gas utilization: (H₂/air)=66%/50%, voltage 0.32 A/cm²).

FIG. 1 schematically shows a plan view of a preferred embodiment of a MEA (100) according to the invention. Further details will be discussed in the description referring to FIG. 2 below.

FIG. 2 schematically shows a cross-sectional view along the dashed line A-B of the MEA (100) illustrated in FIG. 1. The MEA (100) comprises two electrodes (110, 110′) (anode 110 and cathode 110′) and a membrane (120) disposed between the electrodes, which membrane preferably is a polymer electrolyte membrane. Therein, the membrane (120) protrudes beyond the electrodes (110, 110′).

Between the membrane (120) and the two electrodes (110, 110′) opposite thereto, a respective first cover layer (130; 130′) is disposed. The first cover layer (130; 130′) covers a membrane edge face (125, 125′) and an electrode edge face (115, 115′) facing the membrane (120). Therein, the membrane edge face (125, 125′) covered by the first cover layer (130; 130′) is larger than the electrode edge face (115, 115′) covered by the first cover layer (130; 130′).

Furthermore, the MEA (100) includes a second cover layer (140; 140′). Said layer extends from an electrode edge face (117, 117′) facing away from the membrane via an end face (119, 119′) of the electrodes (110, 110′) adjacent thereto up to a surface section (135; 135′) of the first cover layer (130; 130′) adjacent to the electrode end face (119, 119′) and protruding beyond the membrane (120). The protruding surface section (135; 135′), preferably including the end faces thereof, is preferably completely covered by the second cover layer (140; 140′).

On the other hand, the end faces of the membrane (120) are preferably not covered, neither by the first cover layer (130; 130′) nor by the second cover layer (140; 140′).

Due to the fact that the first cover layer (130; 130′) protrudes beyond the membrane edge face (125, 125′), the end faces of the membrane (120) are spaced from the second cover layer (140; 140′) thereby forming a cavity volume (150). As a result, the membrane (120) is with particular advantage given more room or space to allow an improved complying during dimensional variations that occur during swelling and shrinking processes, for example. Due to said “spatial buffer”, the risk of damages to the membrane by mechanical stresses and strains acting thereon can be reduced.

The first cover layer (130; 130′) spaces the electrodes (110, 110′) from the membrane (120). The cavity volume (160, 160′) resulting therefrom is preferably filled with a conductive, in particular an acid-containing, liquid layer. By means of that feature, on the one hand the electric resistance of the MEA (100) may be decreased, what is reflected in particular in an improved performance of the MEA (100). On the other hand, the cavity (160, 160′) also means more freedom of mobility of the membrane (120) in case of swelling and/or shrinking of the membrane (120).

Preferably, there is no material joining, in particular no adhesive, bonding between the first cover layer (130; 130′) and the membrane edge face (125, 125′) covered thereby. Thus, the membrane (120) can slide along the first cover layer (130; 130′) in case of mechanical compressive stress, and allow an improved absorption of forces engaging thereon, like tensile or shearing forces, for example.

Furthermore, it is preferred that between the first cover layer (130; 130′) and the electrode edge face (115, 115′) covered thereby, there is also no material joining, in particular no adhesive, bonding present. Thus, the electrodes (110, 110′) can similarly slide along the first cover layer (130; 130′) in case of mechanical stresses and strains, and thereby compensate the stresses and strains for the membrane (120) at least partially. Thereby, the risk of damaging the membrane (120) may also be reduced.

In contrast, the first cover layer (130; 130′) and the second cover layer (140; 140′) are interconnected preferably by material joining along the common contact surfaces, by means of a polysiloxane adhesive and/or polyacrylate adhesive, for example. Thus, a reliable sealing of the MEA (100) at the edge zones thereof can be obtained.

Furthermore, it is of advantage that the second cover layer (140; 140′) and the electrodes (110, 110′) are interconnected, preferably by material joining, along the common contact surfaces, by means of a polysiloxane adhesive and/or polyacrylate adhesive, for example. Thus, a further optimum sealing of the MEA (100) can be obtained.

The first cover layer (130; 130′) and/or the second cover layer (140; 140′) are in particular a cover film or a sealing film, made of polyether ether ketone, polyphenyl sulfide, polyvinyl sulfide, polyimide, polytetrafluoroethylene, and/or ethylene tetrafluoroethylene, for example, wherein the first cover layer (130; 130′) and the second cover layer (140; 140′) are preferably not a hot-melt film, for the case of a high-temperature application, in particular above 120° C.

Preferably, the first cover layer (130; 130′) is made of polyether ether ketone and the second cover layer (140; 140′) is made of polyphenyl sulfide.

The membrane-electrode assemblies (MEAs) according to the present invention are with particular advantage characterized in that on the one hand, due to the cover layers provided according to the invention there is an improved mechanical stability or strength and an improved prevention of leakages. On the other hand, the MEAs according to the invention are in particular characterized in that the membrane is allowed more freedom of mobility, in particular in case of dimensional variations of the membrane, whereby a risk of damaging the membrane, a membrane failure in the worst case, can be considerably minimized as compared to conventional MEAs. As a summary is noted that the first and the second cover layer of the present invention may adopt the function of protective layers in various aspects with particular advantage. In other words, the first and the second cover layer may be called protective layers.

FIG. 3 shows a graph of the cell voltage (ordinate) as a function of the amperage (abszissa) for a MEA according to the invention including two cover layers and a conventional MEA having merely one single cover layer. In case of the MEA according to the invention, the first or inner cover layer is a film made of polyether ether ketone and the second cover layer is a film made of polyphenyl sulfide. In case of the conventional MEA, the only cover layer is a Kapton film coated by polytetrafluoroethylene (PTFE). In both cases a commercially available membrane named Fumapem® F-930 is inserted. The MEAs were operated at a temperature of 80° C. The residual moisture on the cathode was in each case 60%, the residual moisture on the anode was in each case 80%. Measurements were performed during a period of 300 hours at a hydrogen pressure of 1 bar. The characteristic curves of the MEAs illustrated in the graphs of FIG. 3 are recorded at the beginning and at the end of the test period.

The curve illustrating diamond symbols is the characteristic of the conventional MEA at the beginning of the test (MEA 1, BOL), while the curve illustrating circle symbols is the characteristic of the conventional MEA at the end of the test (MEA 1, EOL).

On the other hand, the curve illustrating square symbols is the characteristic of the MEA according to the invention at the beginning of the test (MEA 2, BOL) and the curve illustrating triangular symbols is the characteristic of the MEA according to the invention at the end of the test (MEA 2, EOL).

FIG. 3 illustrates that in case of the conventional MEA the characteristic curve recorded at the end of the test significantly decreases as compared to the characteristic curve recorded at the beginning of the test.

In contrast, in case of the MEA according to the invention the characteristic curve recorded at the end of the test exhibits an almost identical progress as compared to the characteristic curve recorded at the beginning of the test.

In other words, the performance of the MEA according to the invention has hardly dropped even after a test time of 300 hours, while with the conventional MEA there is a significant performance loss to be observed.

FIG. 4 illustrates the cell voltage-time characteristic of a MEA according to the invention including two cover layers in comparison to a conventional MEA including merely one cover layer. The membrane used is a commercially available high-temperature polymer electrolyte membrane named Fumea®. In case of the MEA according to the invention, the first or inner cover layer employed is a film made of polyether ether ketone and the second or exterior cover layer is a film made of polyphenyl sulfide. With the conventional MEA, the cover layer employed is a Kapton film coated by polytetrafluoroethylene (PTFE). The fuel cells were operated at a temperature of 160° C., a stoichiometric ratio of hydrogen to air of 1.5:2.0 and an amperage of 0.32 A/cm².

The upper curve (MEA with inner cover layer) is a characteristic curve of the MEA according to the invention, while the lower curve (MEA without inner cover layer) is a characteristic curve of the conventional MEA.

The voltage-time characteristic curves presented in the graph of FIG. 4 clearly exhibit that the MEA according to the invention allows a higher cell voltage and thus an improved performance during the entire test period as compared to the conventional MEA.

In total, the FIGS. 3 and 4 show in the graphs of the characteristic curves that MEAs according to the invention are superior both in a low-temperature range and also in a high-temperature range as compared to conventional MEAs.

1. A membrane-electrode assembly (100), comprising two electrodes (110, 110′) and a membrane (120), preferably a polymer electrolyte membrane (PEM), which is disposed between the two electrodes (110, 110′), wherein the membrane-electrode assembly (100) comprises a first cover layer (130; 130′) and a second cover layer (140; 140′) on at least one flat side, preferably on both flat sides of the membrane (120), characterized in that the first cover layer (130; 130′) covers an edge face (125, 125′) of the membrane (120) and an electrode edge face (115, 115′) facing the membrane (120) and the second cover layer (140; 140′) partially covers the first cover layer (130; 130′), preferably in edge regions of the membrane-electrode assembly (100).

2. The membrane-electrode assembly (100) according to claim 1, characterized in that the membrane edge face (125, 125′) protrudes beyond the electrode edge face (115, 115′), wherein the membrane edge face (125, 125′) covered by the first cover layer (130; 130′) preferably is larger than the electrode edge face (115, 115′) covered by the first cover layer (130; 130′).

3. The membrane-electrode assembly (100) according to claim 1, characterized in that the membrane (120) and at least one of the two electrodes (110, 110′) are spaced from one another by the first cover layer (130; 130′), preferably by forming a cavity volume (160; 160′).

4. The membrane-electrode assembly (100) according to claim 1, characterized in that between the membrane (120) and at least one of the two electrodes (110, 110′) an acid-containing, in particular phosphoric acid-containing, liquid layer is present.

5. The membrane-electrode assembly (100) according to claim 1, characterized in that the first cover layer (130; 130′) protrudes beyond the membrane edge face (125, 125′).

6. The membrane-electrode assembly (100) according to claim 1, characterized in that the second cover layer (140; 140′) covers a surface section (135; 135′) of the first cover layer (130; 130′), said section protruding beyond the electrode edge face (115, 115′) and preferably the membrane edge face (125, 125′).

7. The membrane-electrode assembly (100) according to claim 1, characterized in that the second cover layer (140; 140′) extends from an electrode edge face (117, 117′) facing away from the membrane via an electrode end face (119, 119′) adjacent thereto up to a surface section (135; 135′) of the first cover layer (130; 130′) adjacent to the electrode end face (119, 119′) and protruding beyond the electrode edge face (115, 115′) and preferably the membrane edge face (125, 125′), wherein the protruding surface section (135; 135′), preferably including the end faces thereof, is covered by the second cover layer (140; 140′).

8. The membrane-electrode assembly (100) according to claim 1, characterized in that between the membrane (120) and the second cover layer (140; 140′) a cavity volume (150) is located.

9. The membrane-electrode assembly (100) according to claim 1, characterized in that between the first cover layer (130; 130′) and the membrane edge face (125, 125′) covered thereby, there is no material joining, in particular no adhering, bonding, preferably no adhesive bonding.

10. The membrane-electrode assembly (100) according to claim 1, characterized in that between the first cover layer (130; 130′) and the electrode edge face (115, 115′) covered thereby, there is no material joining, in particular no adhering, bonding, preferably no adhesive bonding.

11. The membrane-electrode assembly (100) according to claim 1, characterized in that the second cover layer (140; 140′) has a larger area than the first cover layer (130; 130′).

12. The membrane-electrode assembly (100) according to claim 1, characterized in that the first cover layer (130; 130′) and/or the second cover layer (140; 140′), preferably the first cover layer (130; 130′) and the second cover layer (140; 140′), are a film, in particular a cover or sealing film, wherein the film preferably is not a hot-melt film.

13. The membrane-electrode assembly (100) according to claim 1, characterized in that the first cover layer (130; 130′) and/or the second cover layer (140; 140′) are made of a polymer which is preferably selected from the group consisting of polyether ether ketone, polyphenyl sulfide, polyimide, polytetrafluoroethylene, polytetrafluoropropylene, polyhexafluoropropylene, ethylene tetrafluoroethylene, copolymers thereof, and mixtures or blends thereof.

14. The membrane-electrode assembly (100) according to claim 1, characterized in that the membrane (120) is doped with an acid, in particular an inorganic acid, preferably phosphoric acid.

15. The membrane-electrode assembly (100) according to claim 1, characterized in that the electrodes (110, 110′) are gas diffusion electrodes.

16. A fuel cell, in particular a high-temperature fuel cell, comprising a membrane-electrode assembly (100) according to claim 1.
